(19) United States
(12) Patent Application Publication
(10) Pub. No.: US 2008/0129226 A1
(43) Pub. Date: Jun. 5, 2008

(54) Simulated Open Flame Illumination

(75) Inventors: Donald E. DeWitt, Syracuse, IN (US); Daniel A. Heuer, New Carlisle, IN (US)

Correspondence Address: CARY R. REEVES, 13902 Meadowbrook Drive, Broomfield, CO, 80020, US

(73) Assignee: INNOVATIVE INSTRUMENTS, INC., Syracuse, IN (US)

(21) Appl. No.: 11/946,058

(22) Filed: Nov. 28, 2007

Related U.S. Application Data
(60) Provisional application No. 60/872,858, filed on Dec. 5, 2006.

(51) Int. Cl. H05B 37/02

(52) U.S. Cl. 315/307

(57) ABSTRACT

The present invention provides a simulated open flame illumination device and method. In one aspect of the invention, the simulated open flame illumination device includes a light producing element and a light driver operable to vary the light output intensity of the light producing element over time. The light driver drives the light producing element to produce random output intensities for random durations to mimic the dynamic characteristics of an open flame. In another aspect of the invention, a method of simulating open flame illumination, includes illuminating a light producing element for a first random duration at a first random intensity level and illuminating the light producing element for a second random duration at a second random intensity level to mimic the dynamic characteristics of an open flame.

This application claims the benefit of U.S. Provisional Application No. 60/872,858 filed Dec. 5, 2006.

### FIELD OF THE INVENTION

The invention relates to simulated open flame illumination. More particularly, the invention relates to a flameless candle or other flame based illumination device and optional modular components that may include changeable scent packs, globes, translucent inserts, trim rings, and/or other components.

### BACKGROUND

Open flame illumination has evolved from a nighttime necessity to an esthetically pleasing decoration. A flameless simulation of open flame illumination is appealing due to its safety and cleanliness as opposed to an actual open flame. Previous attempts at producing simulated open flame illumination have resulted in unconvincing electrically lit simulations.

An important aspect of an open flame illumination is its fragrance. For example, candles are produced from a variety of materials and include a variety of aromatics so that they release a pleasing fragrance while they burn. Likewise, lanterns, gas flames, and other open flame illumination devices produce a distinctive odor. In order to be convincing, simulated open flame illumination should smell like a real open flame.

Open flame illuminators, such as candles, are also produced in a variety of shapes, colors, and textures. They are also produced with varying graphics and embedded objects. All of this variation is intended to suit various decorating requirements, to provide seasonal themes, and to otherwise permit flexibility in decorating with open flame.

### SUMMARY OF THE INVENTION

The present invention provides a simulated open flame illumination device and method.

In one aspect of the invention, the simulated open flame illumination device includes a light producing element and a light driver operable to vary the light output intensity of the light producing element over time. The light driver includes a random number generator and a controller operably connected to the light producing element. The controller is responsive to a random number generated by the random number generator to drive the light output intensity of the light producing element to a random value. The duration that the light producing element is driven at the random intensity is also random such that the light driver drives the light producing element to produce random output intensities for random durations to mimic the dynamic characteristics of an open flame.

In another aspect of the invention, a method of simulating open flame illumination, includes illuminating a light producing element for a first random duration at a first random intensity level and illuminating the light producing element for a second random duration at a second random intensity level to mimic the dynamic characteristics of an open flame.

### BRIEF DESCRIPTION OF THE DRAWINGS

Various examples of the present invention will be discussed with reference to the appended drawings. These drawings depict only illustrative examples of the invention and are not to be considered limiting of its scope.

FIG. 1 is a perspective view of a flameless candle according to the present invention;

FIG. 2 is an exploded perspective view of the flameless candle of FIG. 1;

FIG. 3 is a side elevation view of the flameless candle of FIG. 1;

FIG. 4 is a cross-sectional view taken along line 4-4 of FIG. 3;

FIG. 5 is a cross-sectional view taken along line 5-5 of FIG. 3 showing a globe rotated to a first position;

FIG. 6 is a cross-sectional view as in FIG. 5 showing a globe rotated to a second position;

FIG. 7 is a cross-sectional view of a scent pack component of FIG. 2;

FIG. 8 is a cross-sectional view of a scent pack component of FIG. 2 illustrating an alternative wall configuration;

FIG. 9 is a cross-sectional view similar to that of FIG. 4 with the scent pack of FIG. 8;

FIG. 10 is a circuit diagram of a flame simulation circuit;

FIG. 11 is a circuit diagram of a flame simulation circuit;

FIG. 121 is a process flow diagram of a flame simulation produced by the flame simulation circuit of FIG. 11; and

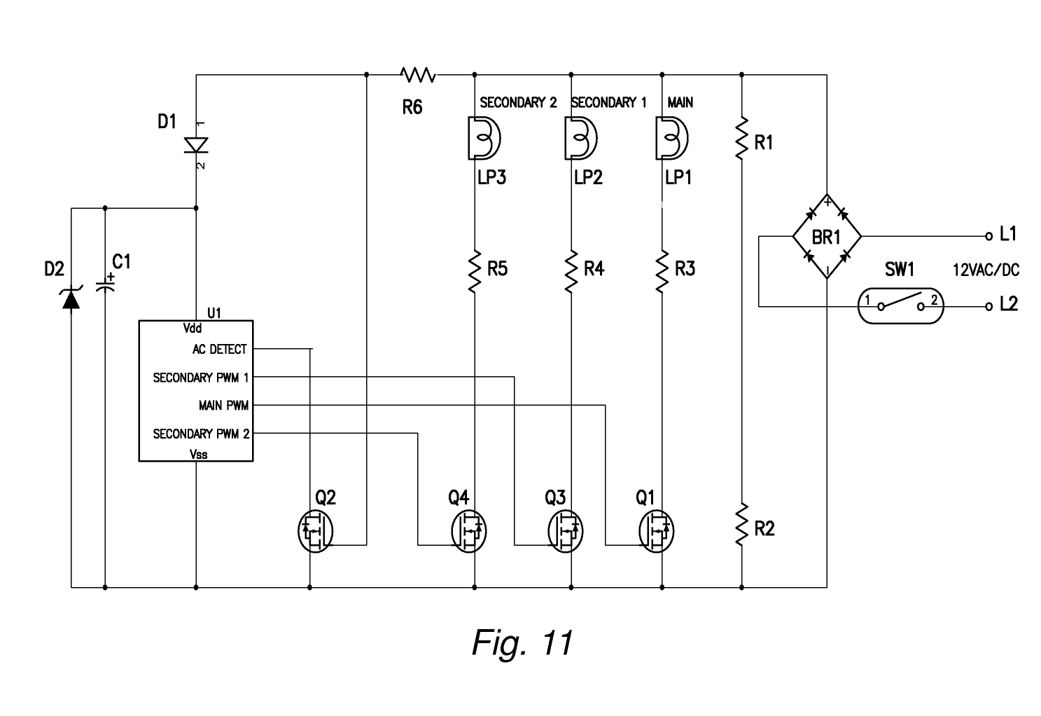

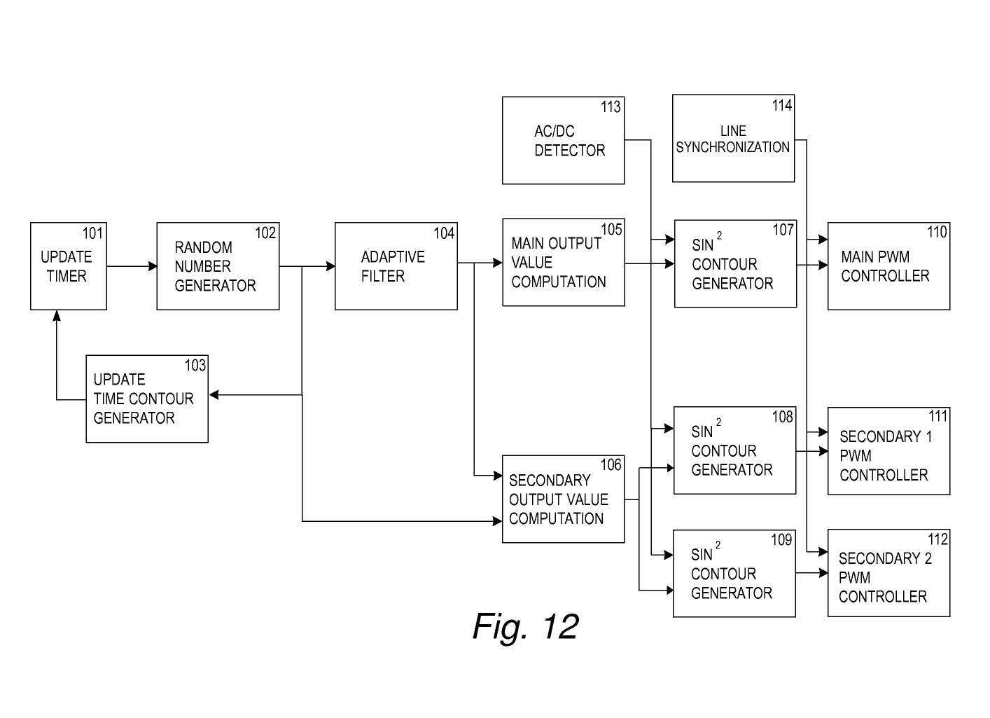

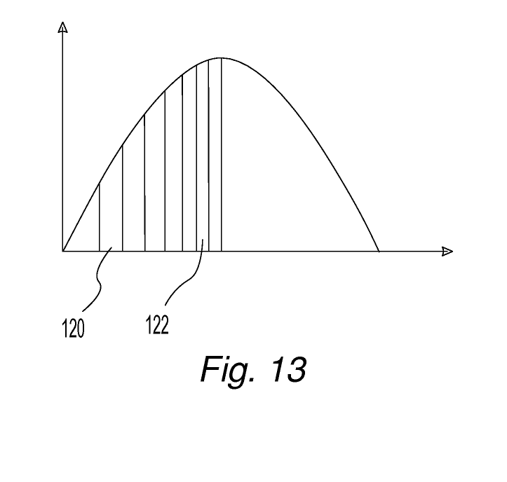

FIG. 13 is a chart depicting a sine² curve illustrating one aspect of the flame simulation circuit of FIG. 11.

### DESCRIPTION OF THE ILLUSTRATIVE EXAMPLES

Embodiments of the present invention provide realistic simulated open flame illumination. The flame simulation is capable of simulating the dynamic behavior of a flame that is influenced by random variations caused by air turbulence. The lighting, aroma, decorative, and other aspects of the invention may be applied to any open flame illumination device. Examples of open flame illumination include candles, lanterns, gas flames, burning wood, torches, oil lamps, alcohol lamps, and/or other open flame devices. For example, the globe and base may be modeled after a lantern and the scent pack may include fragrance reminiscent of a lantern. Similarly, the simulated open flame illumination may be tailored to simulate any other open flame device. However, for simplicity, the illustrative embodiments are directed to a flameless candle and the simulation is referred to in the context of a candle throughout this specification.

The flameless candle includes a flame simulation that mimics the physical and thermal characteristics of a candle flame to produce a convincing simulated flame. Furthermore, the flameless candle may include optional changeable scent packs that simulate the fragrance of a burning candle. The flameless candle may also include modular design elements that allow the candle to be easily customized in manufacturing and/or by the end user to adapt the candle to meet a variety of decorating needs.

In order to convincingly simulate a candle flame, the color, intensity, and dynamic behavior of a real candle flame have been characterized by the present investigators and included in the behavior of the simulated flame. A light source is the starting point for the simulation. A variety of light sources may be used. These light sources may include incandescent bulbs, light emitting diodes, organic light emitting diodes, neon or other gas discharge bulbs, fluorescent bulbs, and/or other light sources. For example, a miniature incandescent light bulb may be used. Incandescent bulbs conveniently have chromatic characteristics closely resembling an actual candle when driven at an appropriate power level. The light source may include mixing of different colored light sources and/or light filtration to improve the simulation. Because of the incandescent bulb being naturally similar to a flame, it is an inexpensive starting point for the simulation. The simulation may include one or more bulbs.

The simulation may also include methods to conceal the actual light source and produce a visual effect resembling flame. For example, since the filament of an electric bulb tends to produce a point source of light, the one or more bulbs may be enclosed in a diffuser that better conforms to the general shape of the simulated flame. The diffuser may be more or less opaque depending on the level of concealment desired. The diffuser may also be neutrally colored so that it does not change the color of light produced by the bulb. Alternatively, it may be colored to modify the color of light produced. The change in color may be used to better simulate a natural flame color, to produce a colored light to simulate light shining through colored glass, and/or to produce some other colored light effect.

The light simulation may also include simulation of the dynamic characteristics of a natural flame. At its most rudimentary level, a candle flame is produced by the exothermic combustion of the wax fuel developing a sustained high temperature plasma which radiates energy over a wide spectrum from infrared through visible light. In equilibrium, the rate of heat produced by combustion exactly matches the rate at which heat is radiated and conducted into the surrounding environment. Without external perturbation the flame will form a surface shape dictated by both radiative and convective heat loss. A device optimized for illumination would attempt to preserve this steady state and maximize both radiated light output and stability. However, since the simulated light source is intended as accent type lighting, the present investigators have discovered that a less stable flame produces a more pleasing effect.

An open candle flame is influenced by external drafts and other disturbances of the air. The flicker associated with a candle flame is the dynamic behavior of the flame attempting to return to or achieve thermodynamic equilibrium after some disturbance. A realistic simulation of this dynamic behavior may incorporate certain key elements. When disturbed, the flame will expand to a point where heat losses at the surface exceed its ability to sustain the combustion process. At this point the temperature of the plasma will drop and the size of the flame will diminish to a point where the heat generated can support the aggregate heat loss. Both the size and intensity will diminish at this point. In this mode vertical changes in the flame will occur with maximum light output at the point where maximum surface area exists. This is a random event based on both the random air movement and the stochastic behavior of the flame itself.

Another element of the dynamic behavior of a candle flame is the lateral movement of the flame tip. Horizontal air movements will cause these lateral disturbances in the flame. These movements will be more pronounced at the upper tip of the flame where the flame is spread by a convective process and is further from the fuel source making it more susceptible to lateral disturbance.

Another element of the dynamic behavior of a candle flame is the time rate of change of the light amplitude and physical movement of the flame. As the size of the flame is controlled by the rate at which heat is generated by the combustion process, so will the time element of the dynamic behavior. As the flame departs from its optimal equilibrium, the time over which the disturbance can be sustained will diminish inversely with the amplitude of the disturbance. Thus a large disturbance will be completed within a shorter time interval than a small disturbance. The rate at which disturbances are applied will greatly influence the appeal of the flicker behavior. Too fast a rate may produce a more distracting effect, as in a windstorm. Too slow a rate may make the change imperceptible. Thus various timing elements may be considered when simulating a flame.

The dynamic nature of the flame may be simulated using various electronic circuits. For example, a simple analogue timer circuit may be used. For example, two timers may be connected in such a way as to vary the current through an LED in a pseudo-random manner which produces a simulation of the varying intensity of a candle flame. Two LED's may be positioned in close proximity such that the light from the two sources mixes to form a combined light close to the color temperature of an actual candle flame. For example, a first LED with a warm white color temperature may be continuously powered and form the primary illumination source. A second LED with a yellow color may be powered from a continuous current source and from circuitry associated with the two timers that produce a variable current source. The continuous power source may establish a lowest illumination level while the timer sources modulate this level higher in intensity depending on their state.

The timers may be set to slightly different frequencies and/or duty cycles and allowed to run asynchronously from each other. When the output from a timer is at a low state, no current will be provided to the LED. When the output is in a high state, a current flow is provided to the LED. As the timers operate they will additively combine their output current to the constant current and vary the intensity of the LED. Since these are asynchronous from each other they will form a timing pattern which is approximately random within a period of time and thus will produce a visually pseudo random light variation.

In another example, a digital circuit may be used. The light source may be driven by a pulse width modulated (PWM) signal produced by a logic control device. The PWM signal may control the luminous intensity of the light source in proportion to the duty cycle of the PWM signal. The circuit may include a microprocessor containing a set of instructions which produces the PWM signal. The PWM signal may be derived from a random number generator to better simulate the random nature of open flame illumination. The random number may be filtered to average the random numbers and smooth the transition from one number to the next. This may be an adaptive filter in which the filter coefficient is altered based on the random numbers to more closely match the dynamics of a flame based illumination device.

The filtered value may be used in a deterministic mechanism to produce a numeric value, which is used to produce a pulse width modulated signal, which has defined minimum and maximum amplitudes. This pulse width modulated signal may be used to drive a light source.

The simulation may include producing one or more additional pulse width modulated signals to control one or more additional light sources. The additional light sources may be illuminated alternately, with both the selection of which additional light source to light and the intensity of the secondary light source controlled by the random number.

Parameters of the analogue or the digital simulation may be user adjustable. The adjustability may be provided with switches, potentiometers, and/or other user adjustable circuit components. For example, one or more circuit resistors may include a potentiometer to permit changing frequency, duty cycle, current, voltage, and/or other circuit parameters to allow user customization of the simulated flame characteristics. Similarly controls such as switches, potentiometers, and/or other user adjustable circuit components may be referenced by a microcontroller that takes logical alternatives based on the adjustable circuit component settings.

Where two or more light sources are used, the light sources may be arranged with the primary light source vertically lower than the others. This light source may be constantly lit with varying intensity. The secondary light sources may be positioned above the primary light sources and lateral to one another such that alternating illumination will simulate the vertical and lateral movement of a flame.

The flameless candle may be powered by batteries and/or by plugging into a wall outlet. The flameless candle may be powered directly from wall outlet voltages or through a separate transformer connected between the wall outlet and the circuit board. A separate transformer may provide alternating current or direct current to the circuit board. The circuit board may be designed to work with either alternating or direct current. For example, the circuit board may include a voltage divider to step the supplied voltage down to a suitable level and a rectifier to convert AC to DC.

The power for the light sources may be produced by an AC or rectified AC power source whose voltage is described by a sinusoidal waveform in which the duty cycle of the pulse width modulated signal is proportional to a sine squared function in which each incremental step represents an equal power increment or equal area segment under the sine squared curve. The internal intensity value may be translated into this equal power segmentation such that each step in the intensity value corresponds to an equal power dissipation step in the sinusoidal drive voltage and thus corresponds to equal increments in intensity.

The simulation may include a fragrance generator. The fragrance generator may use a volatile gel, a volatile oil, and/or other fragrance producing substances (fragrance). The fragrance generator may include a heating element, a fan, a wick, and/or other suitable device to vaporize the fragrance and emit it into the surrounding air. The fragrance may be provided in a modular scent pack that is easily changed to replenish the fragrance and/or allow changing the scent. The scent pack may include a central opening for receiving the flame simulator to simulate a candle flame at the center of a wax candle. The central opening may be round, rectangular, or any other shape. The central opening may include a projection that extends upwardly around the flame simulator to provide a light diffuser, a color filter, a handle, a protective shield to prevent volatile fragrances from soiling the flame simulator, and/or to provide other functions. The projection may be open ended or it may be closed. For example, a scent pack may be provided that includes a cylindrical pan open at one end and including a flame shaped central projection that defines a socket for receiving the flame simulator.

The flameless candle may advantageously include a modular construction to permit customization during manufacturing to address different markets and/or seasonal needs. The modular parts may also be provided to the end user to allow the end user to customize the candle. Modular components may include globes, globe inserts, trim rings, scent packs, and/or other modular components. For example, globes with varying colors, patterns, shapes, and/or textures may be provided. For example, seasonal globes with printed or painted holiday scenes may be provided to allow the candle to be adapted for the season. Similarly, translucent inserts may be provided that insert between the globe and simulated flame. The inserts may include diffusers, color filters, light passages for projecting light images onto the globe, opaque patterns for projecting shadows onto the globe, and/or other inserts. The flameless candle may incorporate a modular trim ring that covers the base of the candle and is changeable to vary the color, shape, decorative patterns, and/or other aspects of the base.

The flameless candle may be activated in a variety of ways. For example, it may be always on whenever a power source is connected to it. Alternatively, it may have an on/off control. The on/off control may include a photo sensor to automatically turn the candle on and off at predetermined ambient light levels. The on/off control may be activated by one or more elements of the candle assembly such that the candle will only operate when properly assembled. For example the on/off control may form an interlock with one or more elements such as the scent pack and/or globe. Thus, if the candle is tipped over or otherwise disturbed causing the interlocked element to be displaced the candle will shut off. Such an interlock may include switches activated by depressing a button, magnetic forces, photo sensors, and/or other suitable switches. For example, one or more magnetically sensitive switches can be incorporated into the candle circuitry such that a magnet attached to the globe and/or scent pack must be properly positioned for the candle to operate. A switch may also be incorporated such that rotation of an element of the candle activates the candle. For example, a magnet attached to the globe may activate the candle when the globe is rotated to a predetermined position.

Additionally, the light intensity may be varied to adapt to differing lighting conditions. A photo sensor may be included that senses the ambient light level. The output of this sensor may be used to control the candle light intensity such that at high ambient light levels a relatively high intensity is produced. At low ambient light levels the candle light intensity may be reduced. In this way the simulated flame is visible at high ambient light conditions but is reduced to a suitable accent lighting level at low ambient light conditions.

The candle may also include a mechanism to modulate the fragrance output from the scent pack. The mechanism may include varying the temperature of the scent pack, varying the airflow around the scent pack, and/or other mechanisms. For example, the scent pack may be heated by an adjustable heat source. The airflow around the scent pack may be varied by changing the speed of a fan attached to the candle. The airflow around the scent pack may be varied by changing the size of air intake openings in the candle. Any one of these mechanisms may be used alone or they may be used in any combination. For example, the temperature of the heat pack and the size of air intake openings at the base of the candle may be varied together to modulate the fragrance. For example, rotationally adjustable air intake openings may be incorporated into the globe and the candle base and a scent pack heater may be indirectly modulated by a Hall Effect device such that rotating the globe modulates the heater and varies the air intake openings. In another example, the circuit may keep track of the time that the candle is activated and incrementally increase heat to compensate for diminishing fragrance output from the scent pack.

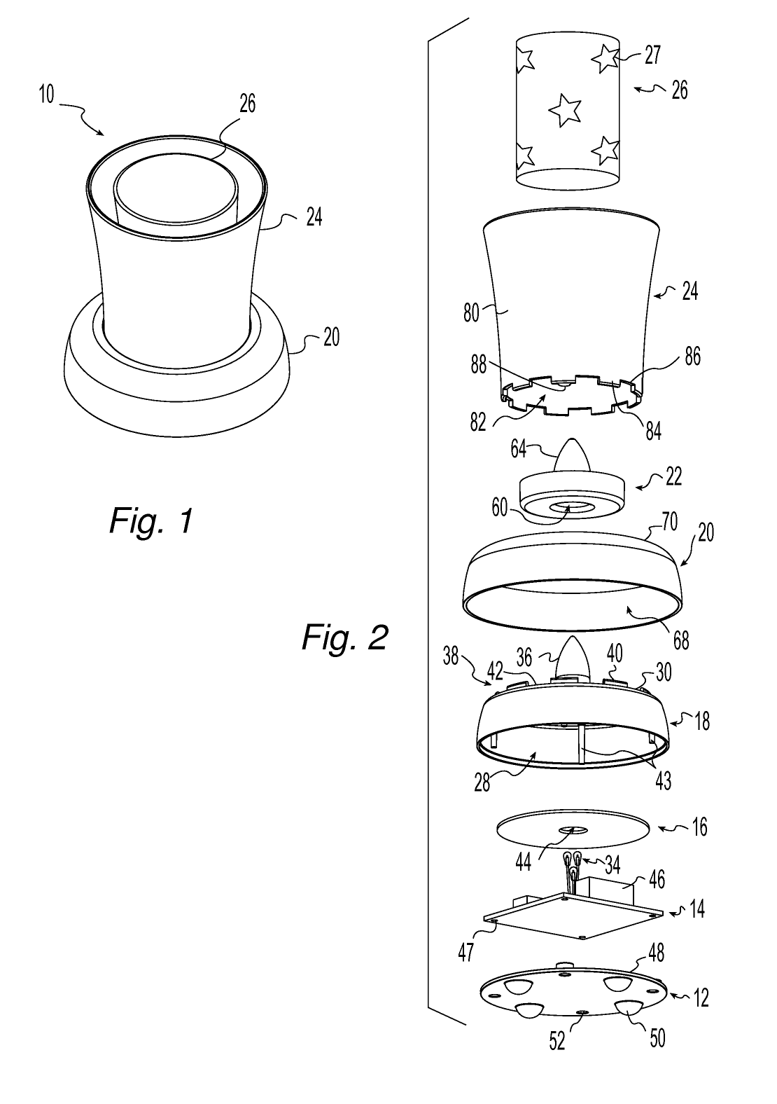

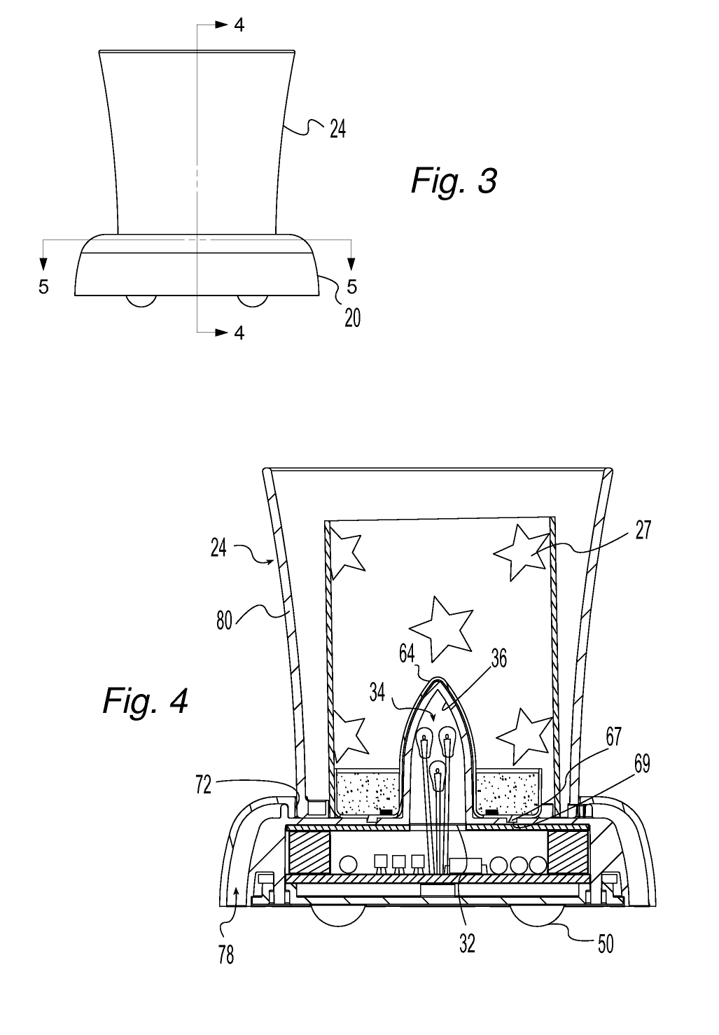

The illustrative flameless candle assembly 10 of FIGS. 1-7 includes a base plate 12, a circuit board 14, a heat plate 16, a luminary base 18, a trim ring 20, a scent pack 22, a globe 24, and a globe insert 26. The base plate, 12, circuit board 14, and heat plate 16, are mounted to the luminary base 18 to form a base assembly. The trim ring 20, scent pack 22, globe 24, and globe insert 26 rest loosely over the luminary base 18 and are easily exchanged to create different effects.

The luminary base 18 defines a hollow shell having an open bottom 28 and a closed top 30. The top 30 includes a central opening 32 (FIG. 4) for receiving an array of bulbs 34. In the illustrative embodiment, a bulb shroud 36 surrounds the central opening 32 and extends upwardly generally in the shape of a candle flame. The bulb shroud 36 is translucent and diffuses the light from the array of bulbs 34. The bulb shroud 36 may optionally be tinted to act as a color filter for changing the color of the simulated flame. An interrupted ring 38 projects upwardly from the top 30 of the luminary base 18. The ring 38 includes tabs 40 and intervening notches 42 and forms part of an adjustable air passage through the candle 10. Stakes 43 project inside the luminary base 18 and terminate near the bottom 28. Preferably, the luminary base 18 is molded from plastic.

The heat plate 16 is a circular disc having a central opening 44 for receiving the array of bulbs 34. The heat plate 16 is preferably made of a conductive material so that it readily transmits heat. In the illustrative example, the heat plate 16 is made of aluminum.

The circuit board 14 includes a heating element and a flame simulation circuit. In the illustrative example, the heating element includes a pair of power resistors 46. The flame simulation circuit drives the array of bulbs 34 as will be explained further below. The circuit board includes holes 47 configured to align with the stakes 43 of the luminary base 18.

The base plate 12 includes a generally planer disc 48, depending molded feet 50, and holes 52 configured to align with the stakes 43 of the luminary base 18.

The base is assembled by placing the heat plate 16 through the bottom 28 of the luminary base 18 and into contact with the underside of the top 30. The circuit board 14 is next placed through the bottom 28 of the luminary base 18. The bulbs 34 are inserted through the heat plate 16 and into the bulb shroud 36. The holes 47 engage the stakes 43. The base plate 12 is then placed through the bottom 28 of the luminary base 18 with the holes 52 engaged with the stakes 43. The base plate 12 is slid over the stakes 43 to abut the circuit board 14 and press the power resistors 46 firmly against the heat plate 16. The stakes 43 are then heat deformed to hold the assembly together. In this way, a tight fit of the resistors 46 against the heat plate 16 is assured.

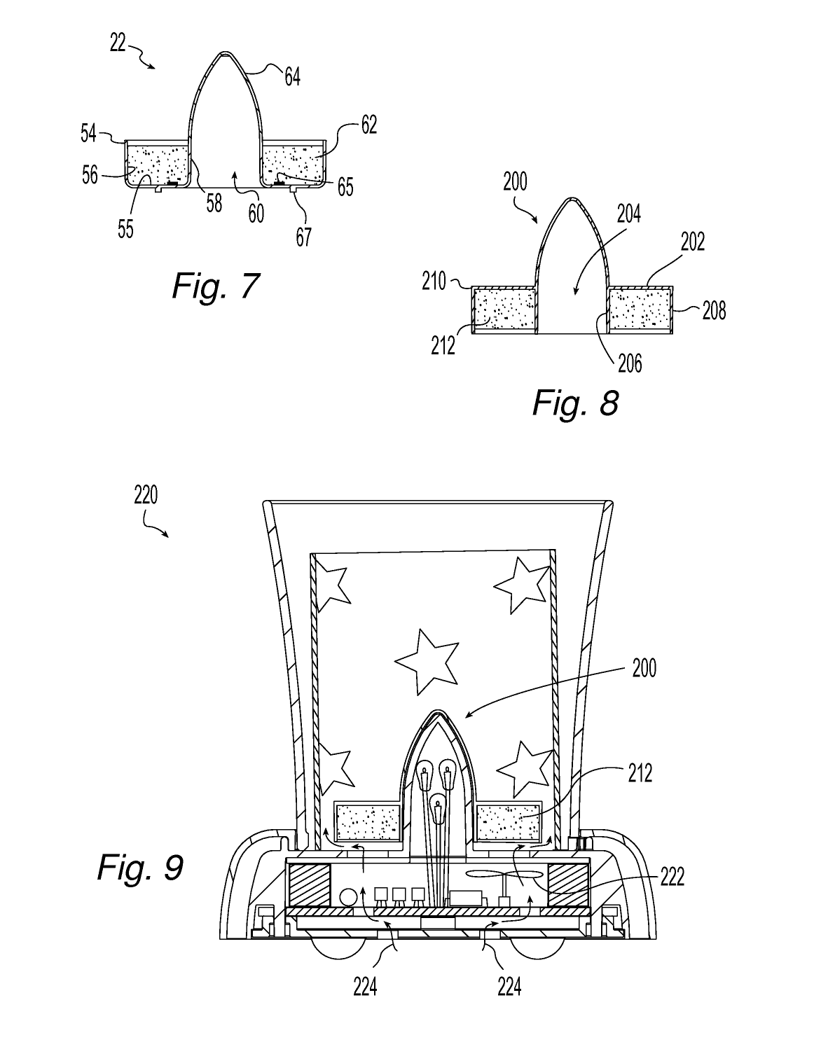

The scent pack 22 (see FIG. 7) includes a base wall 55 defining an opening 60. An inner side wall 58 extends away from the base wall 55 and surrounds the opening 60. An outer side wall 56 extends away from the base wall 55 and surrounds the inner side wall 58 such that the base wall 55, inner side wall 58, and outer side wall 56 define an annular tray 54 surrounding the opening 60. In the embodiment of FIG. 7, the base wall 55 is in the form of a bottom wall and the side walls 56, 58 extend upwardly to define an upwardly opening annular tray 54. While shown with cylindrical side walls, the scent pack 22 sidewalls may be any shape. For example, the side walls may be triangular, rectangular, hexagonal, or be in the shape of any other polygon, regular curve, irregular curve, and or random shape. The scent pack 22 is filled with a volatile fragrance 62 such as an aromatic gel, oil, wax and/or other suitable fragrance. The scent pack 22 may also include an optional wick (not shown). The central passage 60 receives the bulb shroud 36 of the luminary base 18 to simulate a candle flame at the center of a wax candle. In the illustrative scent pack 22, the inner wall 58 extends upwardly to form a central projection 64. The central projection 64 is closed at the top and generally conforms to the shape of the bulb shroud 36. The central projection 64 may be frosted to further diffuse light from the bulbs 34. The central projection 64 may also be tinted to act as a color filter to change the color of the light. Scent packs 22 may be provided in a variety of configurations of scent, light diffusion, and color filtration to allow customization of the light and scent characteristics of the candle. The central projection 64 provides a protective shield to prevent the volatile fragrance 62 from soiling the bulb shroud. Thus, with each change of the scent pack 22, a clean light path is provided. Finally, the central projection 64 provides a handle to facilitate gripping the scent pack 22 for insertion and removal. The scent pack is preferably molded in plastic.

The scent pack 22 is placed over the bulb shroud 36 with the floor 55 of the scent pack 22 in contact with the top 30 of the luminary base 18. The illustrative scent pack 22 includes an optional ring shaped magnet 65 attached to its floor 55 as part of an interlock system to ensure that the flameless candle only operates when the scent pack 22 is properly in place on the flameless candle. The interlock includes a reed switch or other magnetically sensitive circuit component in the flameless candle circuit that turns the flameless candle off when the scent pack is not in position on the luminary base 18. For example, if the flameless candle is tipped over and the scent pack becomes dislodged, the flameless candle will turn off. The illustrative scent pack 22 also includes a downwardly projecting ring 67 molded onto the floor 55. The ring 67 engages a groove 69 in the top of the luminary base 18. The groove 69 contains a switch (not shown) that is activated by the ring 67 pressing downwardly into the groove. The switch turns the flameless candle off when the scent pack is not in position on the luminary base 18. For example, if the flameless candle is tipped over and the scent pack becomes dislodged, the flameless candle will turn off. Both the magnetic interlock and the projecting ring interlock are optional and can be used independently of one another or in combination. Other interlock geometries may be substituted for these including one or more projecting dimples, splines, and/or other geometries. Other interlock devices may be substituted for these including a photo sensor, Hall Effect device, variable resistor, liquid filled switches, and/or other types of devices.

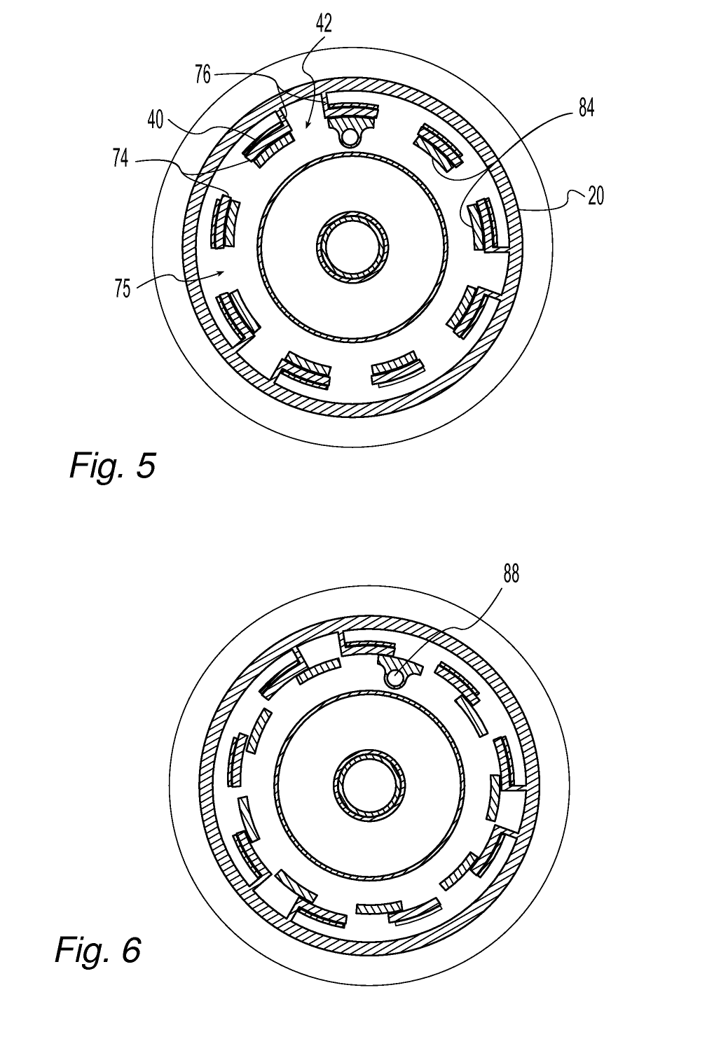

The trim ring 20 defines a hollow shell 66 having an open bottom 68 and a top 70. The top 70 defines a central opening 72 (FIG. 4) sized to receive the globe 24 in sliding fit relationship. The trim ring 20 includes annular tabs 74 (FIG. 5) extending downwardly from the top 70 near the central opening 72 and separated by notches 75. At least some of the tabs 74 connect to radial ribs 76. In the illustrative trim ring 20 of FIG. 5, three pairs of ribs 76 are provided. Each pair of ribs 76 has a spacing less than the width of a corresponding notch 42 between the luminary base tabs 40. The trim ring 20 rests on top of the luminary base 18 with the trim ring tabs 74 providing vertical spacing between the trim ring 20 and the luminary base 18. The ribs 76 provide rotational alignment of the trim ring notches 75 with the luminary base notches 42 to ensure maximum airflow through the aligned notches.

The trim ring 20 and luminary base 18 define an annular air passage 78 (FIG. 4) between them from the bottom of the flameless candle 10 up and around the luminary base and through the notches 42, 75. The feet 50 of the base plate 12, elevate the luminary base 18 and trim ring 20 above the counter surface to provide for air entry into the air passage 78 through the bottom of the flameless candle 10. The trim ring 20 may be provided in a variety of styles, colors, textures, and/or other characteristics to permit customization of the flameless candle 10. The trim ring 20 may include figures, scenes, patterns, and/or other depictions molded into it or applied to it to vary its appearance. For example, various seasonal themes may be printed on the trim ring 20 and used in manufacturing and/or provided to the consumer for seasonal customization. The trim ring is preferably molded from plastic.

The globe 24 includes a generally cylindrical open ended wall 80. The base 82 of the globe 24 defines a ring of alternating tabs 84 and notches 86. The globe 24 rests on top of the luminary base 18 and defines a slip fit inside of the central opening 72 of the trim ring 20. The globe 24 is rotatable relative to the luminary base 18 and trim ring 20 from a first position in which the tabs 84 and notches 86 of the globe 24 align with the tabs and notches of the trim ring 20 and luminary base 18 (FIG. 5) and a second position in which the tabs 84 of the globe 24 align with the notches of the trim ring 20 and luminary base 18. The first position provides relatively more air flow through the air passage 78 and the second position provides relatively less flow through the air passage 78. The globe 24 is continuously adjustable from a fully open air flow position to a fully closed position.

The illustrative globe 24 includes a magnet 88 attached to one of the tabs 84. The flameless candle 10 includes a magnetically sensitive switch responsive to the presence of the magnet 88 to turn the flameless candle on. The switch may be a reed switch, a Hall Effect device, and/or other magnetically sensitive device. The globe is rotatable between an off position in which the magnet 88 is spaced from the switch and an on position in which the magnet 88 is near the switch. Preferably the magnet 88 activates the switch over a rotational range so that the flameless candle 10 is turned on over the range of airflow adjustment depicted in FIGS. 5 and 6. The switch, or another one adjacent to it, may also be responsive to the magnet's 88 position to modulate the scent output of the flameless candle. For example, the flameless candle circuit may include a Hall Effect device, an array of reed switches, and/or other magnetically sensitive circuit component, that varies a circuit parameter in response to the globe's position to vary the amount of heat applied to the scent pack 22 and/or to vary the speed of an optional fan attached to the flameless candle. The circuit response may also be coordinated with the air flow openings as varied by the globe's tabs 84 such that when the tabs are in a more open position like that of FIG. 5, the active scent producing aspects of the circuit are driven to produce more scent and when the tabs are in a more closed position like that of FIG. 6, the active scent producing aspects of the circuit are driven to produce less scent. Other forms of modulation may be substituted for the magnetically sensitive circuit component such as a rotating potentiometer, an optical sensor, and/or other suitable circuit components. The globe 24 may be provided in a variety of styles, colors, textures, and/or other characteristics to permit customization of the flameless candle 10. The globe 24 may include figures, scenes, patterns, and/or other depictions molded into it or applied to it to vary its appearance. For example, various seasonal themes may be printed on the globe 24 and used in manufacturing and/or provided to the consumer for seasonal customization. The globe is preferably molded from plastic.

The illustrative globe insert 26 is generally in the form of a cylindrical sleeve that fits within the globe 24. However, the globe insert 26 may have any shape that fits inside or outside of the globe 24. The globe insert 26 may be provided in a variety of styles, colors, textures, and/or other characteristics to permit customization of the flameless candle 10. The globe insert 26 may include figures, scenes, patterns, and/or other depictions to vary its appearance. For example, various seasonal themes may be formed as cutouts 27 in the globe insert 26 such that a light pattern corresponding to the theme is projected on the globe 24 in the case of a globe insert 26 placed inside of the globe 24 or such that a lighted cutout scene is directly viewable in the case of a globe insert 26 placed outside of the globe. Similarly, depictions may be created as relatively more opaque areas on the globe insert 26 to cast a corresponding shadow on the globe or produce a backlit silhouette. Likewise, transparent colors may be applied to the globe insert to produce colored depictions. Globe inserts 26 may be used in manufacturing and/or provided to the consumer for customization. The globe insert 26 is preferably molded from plastic.

In use, optional trim rings 20, scent packs 22, globes 24, and globe inserts 26 are positioned on the luminary base 18. The flameless candle 10 is turned on, such as by rotating the globe 24, to activate the flame simulation and heat the power resistors 46. The circuitry on the circuit board 14 activates the bulbs 34 to produce light which is transmitted through the bulb shroud 36, scent pack extension 64, globe insert 26, and globe 24. The heat plate 16 conducts heat from the power resistors 46 to create a relatively uniformly heated heat plate 16. Heat from the heat plate 16 is conducted through the top 30 of the luminary base 18 and the floor of the scent pack 22 to warm the fragrance 62 and disperse it into the air. As the air in the globe 24 warms, convective currents are generated in which warmer air rises and is replaced by cooler air drawn through the annular air passage 78 at the base of the flameless candle 10. Rotating the globe 24 rotates the tabs 84 to provide more or less restriction to the flow of makeup air through the annular passage 78 and consequently the airflow out of the flameless candle and thus modulates the intensity of the scent produced by the flameless candle.

FIGS. 8 and 9 illustrate an alternative arrangement for the scent pack and fragrancer. In the embodiment of FIGS. 8 and 9, the scent pack 200 includes a base wall 202 in the form of a top wall and the inner and outer side walls 206, 208 extend downwardly away from the base wall 202 and surround the opening 204 to form a downwardly opening annular tray 210. The fragrance 212 comprises a gel that will not run out of the tray 210. The fragrancer 220 of FIG. 9 is configured similarly to that of FIG. 4. However, the base includes a fan 222 that draws airflow 224 through openings in the simulated candle and over the fragrance 212 in the scent pack 200.

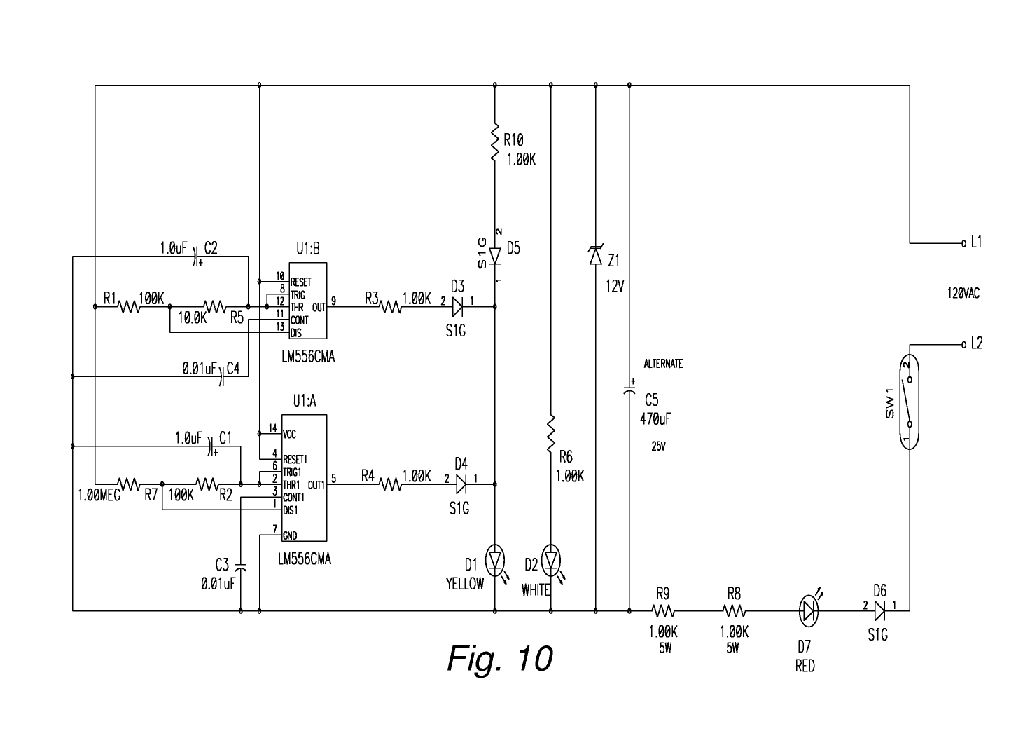

At its most rudimentary level, simulating a flame may be accomplished by changing the intensity of a lamp in a pseudo random pattern. For many applications this proves effective and provides a pleasing effect. FIG. 10 illustrates one possible implementation of this method. Two LED's are operated in parallel. A white LED is illuminated with a fixed current and hence a fixed luminous intensity. A second yellow LED is intensity modulated to simulate flame flicker. The two LED's are positioned in such a way as their light mixes to produce a color temperature similar to an actual flame.

To produce a varying intensity in this embodiment, two timers in the form of astable multivibrator elements are run at slightly different frequencies and/or duty cycles and in such a way that their output circuitry modulate the current through the yellow LED. As they oscillate they add more or less current and change the intensity of the light emanating from the LED. Since they are asynchronous with one another, they will produce a pseudo random variation in this output.

In this embodiment power is provided by a 120 VAC line input. The reed switch SW1 activates the circuitry when a magnet is placed in its proximity such as magnet 88 attached to the globe 24. A rectifier diode D6 produces a half-wave rectified signal through the LED D7, R8 and R9. D7 is intended to provide a level of circuit protection and is not used specifically for illumination. Capacitor C5 filters the half-wave rectified current producing a DC output voltage limited by the Zener diode Z1. This produces a regulated 12-Volt supply for the flame simulator circuitry.

The white LED D2 is powered through resistor R6 from the 12-Volt source, which produces a fixed current through D2. The yellow LED D1 is powered from three sources. R10 and D5 form a fixed current, which establishes a lower limit of intensity from LED D1. Two astable multivibrators, U1A and U1B, produce two slightly different frequency pulses which act through R4, D4 and R3, D3 respectively. D3 and D4 are “steering diodes” which prevent current from flowing back into U1A and U1B when these are in their low state.

There are four different states produced by the circuit of FIG. 10. The first state corresponds to both multivibrators, U1A and U1B, being in their low state and LED D1 being powered only through R10, D5. The second state corresponds to multivibrator U1A being in its high state and multivibrator U1B being in its low state such that LED D1 is powered through both R10, D5 and R4, D4. The third state corresponds to multivibrator U1B being in its high state and multivibrator U1A being in its low state such that LED D1 is powered through both R10, D5 and R3, D3. The fourth state corresponds to both multivibrators being in their high state such that LED D1 is powered through R10, D5; R3, D3; and R4, D4.

The resistance values shown in FIG. 10 for R3, R4, and R10 provide three different intensity values corresponding to 33%, 66%, and 100% of the maximum LED current. Since R3 and R4 are equal, both states two and three will produce 66% of the maximum LED current. When both outputs are at their low state, only the current through R10 will be supplied to the LED D1 and it will be illuminated at its lowest intensity. When one of the multivibrators transitions to a high output voltage level, the current through the LED doubles and the intensity increases roughly in proportion. When both multivibrator outputs are at a high level the current through the LED is three times that at its lowest level with a proportional increase in intensity. If the values are selected differently, then the intensity steps may be varied to produce a different range of intensity variations. If, for example, R3 and R10 are selected to be 1000 Ohms and R4 is selected to be 500 Ohms, then there would be four intensity levels set to 25%, 50%, 75% and 100% of full intensity depending on the combination of currents from the timer outputs. Other ratios may be used to vary the relative intensity variation for other effects such as an occasional higher intensity burst as happens when a more intense disturbance influences a candle flame.

The timing for the multivibrator U1A is controlled by resistors R2, R7 and capacitor C1. Likewise, resistors R1, R5 and capacitor C2 control the timing of the multivibrator U1B. Adjusting the value of these components will allow the timing to be varied and hence the flicker pattern duration.

This circuit is intended to be representative of one possible embodiment of this invention. Other configurations may be used without altering the spirit of the invention. For example, the circuit may be powered using a separate power supply, which may supply either AC or DC power. Additional timers may be added to produce further randomness and LED intensity levels.

FIG. 11 illustrates an illustrative digital flame simulation circuit diagram. In this example, 12 volt AC or DC power is applied to inputs L1 and L2. Reed switch SW1 is controlled by the magnet 88 located in the globe 24. When switch SW1 is activated, current flows through the bridge rectifier BR1 to power the circuitry. The power resistors 46 are represented by R1 and R2. They act as the heating elements as previously described. Diodes D1 and D2, capacitor C1, and resistor R6 form the regulated low voltage power supply required by the microprocessor U1. The full wave rectified voltage produced by the bridge rectifier is detected by transistor Q2, which supplies a pulse to U1 at each zero crossing of the AC input. If the input power supply is DC, no pulse will be produced and the microprocessor U1 will determine that a DC supply is present. Lamp LP1 is the main lamp in the array of bulbs 34 of the flame simulation. Lamps LP2 and LP3 are secondary lamps in the array 34. Transistors Q1, Q3, and Q4 drive the lamps with a pulse width modulated (PWM) signal that allows the microprocessor to control the power dissipated in the lamps. Resistors R3, R4, and R5 limit the current in the bulbs.

FIG. 12 shows a block diagram of the lamp control process operated by the microprocessor U1 of FIG. 11 to produce the candle flame simulation. The central controlling element of the process is the random number generator 102 which produces an 8-bit pseudo random number with uniform probability distribution. True random numbers would produce a series of numbers uniformly distributed over a defined interval with all numbers having equal probability of being generated. The generation of random numbers within a logic device such as a microprocessor necessarily limits the number sequence because the algorithms cannot be fully stochastic. For practical purposes then, generating a sequence of numbers which have equal probability of being produced but which may exhibit a pattern over a long time period is considered adequate when that repeating pattern is long enough to simulate a true random number. These long sequences are referred to as pseudo-random numbers since they do indeed have a pattern. There are numerous methods of performing this. One relatively simple method is described by Donald E. Knuth in Volume 2 of his series “The Art of Computer Programming”. In this reference he describes in detail a function which can produce pseudo random numbers. This function is defined by the following equation:

Xₙ₊₁=(aXₙ+c)modm

Where Xₙ₊₁ is the next random number in a series, Xₙ is a current random number, a is a multiplier and c is an offset value. The function modm is a division operation that produces the remainder value of the division by m. The constants a, c, and m may be chosen for the particular application. In this case a and c were chosen to be prime numbers and m was the byte length value of 256. When implemented this will produce a series of pseudo-random numbers in the range of 0 to 255 with each value having an equal probability of occurrence. The length of the sequence is sufficiently long that for this application it is effectively fully random.

The random number controls the simulated flicker rate and amplitude. The flicker rate is determined by the rate at which the random numbers are generated. More frequent changes will cause a faster flicker response. Likewise, less frequent changes will produce a slower flicker response. Since a candle flame is influenced by random turbulence, the simulated flame must likewise have a random flicker rate. Timer 101 is decremented at a fixed rate. When it reaches zero it triggers the generation of a new random number. This number is converted by the time contour generator 103 which produces a numeric value corresponding to the desired time interval to the next random number generation.

As has been described, a candle flame will attempt to achieve thermodynamic equilibrium and will exhibit a varying time response depending on the amplitude of a disturbance. A large disturbance will have a relatively short duration while a smaller disturbance will have a longer duration. The time contour generator 103 produces a relatively longer update time interval for values at the center of the random number range and will produce a shorter update time interval at either extreme. The random number generated is in the range of 0 to 255. Numbers near the center of this are defined to be nominal while numbers closer to either 0 or 255 will be more extreme. This method allows control of both the overall activity level of the simulated flame as well as the relative duration of the simulated disturbances.

The random number also controls the amplitude of the flicker. Since the random number will produce steps that are unpredictable and potentially large, a means of shaping the intensity transition from one number to the next must be incorporated. A real candle flame will vary smoothly in intensity with the disturbances. A filter is used to smooth the transitions from one intensity level to the next. Although a flame will vary smoothly, it will also respond to large dynamic changes differently than smaller changes. This is often observed as a brief but large flicker. To properly simulate this, the filter response must be adjusted when large transitions occur. Therefore, the filter response is implemented with adaptive filter 104. The basic filter is known to those skilled in the art as a single pole infinite impulse response (IIR) filter. The nominal filter cutoff frequency is set to approximately 0.8 Hz. This provides a smoothed transition from one brightness level to another, which more closely resembles the actual response of a candle. As the filter tends to average the random number input, it also tends to limit peak output. An actual candle flame will have brief instances where a peak value is reached followed by a more rapid decline toward the nominal output level. The filter is adjusted at certain high numeric values from the random number generator to respond more rapidly to these peak changes, and hence adapted based on the input value.

The filtered value is then used by the main output value computation 105 to produce a value suitable to the main PWM controller. We have found that the simulation produces a pleasing effect with the main output bulb set to have a moderate range of brightness variation from approximately 60% to 100% of full power output. This would correspond to approximately ⅓ of the numeric range of the filtered 8-bit random number value and an offset value of ⅔, providing the appropriate values for an 8-bit PWM output. A slightly smaller range was chosen for convenience so the computation performed by the main output value computation 105 scales the filtered value by ¼ so the duty cycle value varies from 75% to 100%. This is done by dividing the input value by 4 then adding a fixed offset of 191, which represent 75% of full scale. This variation was found to be suitable for use with either a single bulb or a multiple bulb implementation.

The secondary output value computation 106 also uses the filtered value but produces a somewhat more radical brightness range. In order to simulate the variation in flame height, the secondary bulbs are illuminated only when the input value exceeds some predetermined value. This threshold was determined to be approximately 33% of the full-scale intensity value. When the intensity exceeds this, the intensity value is scaled to optimally illuminate the secondary bulbs. When the bulbs are not illuminated, a low duty-cycle value is produced which keeps the filament at a temperature just below incandescence. Since incandescent lamps exhibit a non-linear positive temperature coefficient resistance, this keeps the resistance relatively high and limits the inrush current.

To simulate the lateral movement of the flame, one of the two secondary bulbs is selected for illumination based on one bit in the random number while the second bulb is left off. The bulbs alternate in a random pattern. This provides both a random lateral and vertical synthetic movement. This could also be implemented with additional filter elements that produce a smooth transition between the two secondary bulbs and thus an even more realistic simulation of lateral flame movement.

To vary the intensity of the bulbs, the PWM controllers 110, 111, and 112 generate a variable duty cycle waveform that is used to directly drive the bulbs. PWM digital-to-analog converters are known in the electronic arts to require minimum external circuitry to generate an analog signal from its digital representation within a microprocessor or other digital device. In the illustrative example, the bulbs are directly driven from the PWM where their light output is approximately proportional to the duty cycle.

It is desirable to reduce manufacturing costs of the flameless candle. One way this is achieved in the present invention is to eliminate as many components, especially relatively expensive components, as is feasible. One opportunity for reducing the component cost is in the power supply. Typically, lamps are more easily controlled when powered by DC. However, this would require a relatively large and expensive capacitor since the current drawn by the bulbs is relatively high. If the bulbs are driven by AC or rectified but unfiltered AC, this capacitor could be eliminated. However, this poses some difficulties.

With a DC power source, the intensity level varies approximately in direct proportion to the duty cycle of the PWM output. When AC power is used, the PWM output is no longer linearly proportional to the duty cycle due to the sinusoidal voltage being applied to the bulbs. Further, if the PWM is not synchronous with the AC power an interaction known as a beat frequency is produced which develops a highly undesirable effect. To avert this, the PWM output is first synchronized to the line frequency with a period equal to half that of the AC line. Then the PWM period is adjusted to produce equal steps of power delivered to the bulbs.

Since the power dissipation in the bulb is proportional to the square of the voltage applied, the power dissipation in the bulb is proportional to the square of the sine of the time during the input sine wave. Since the AC is full-wave rectified, only half of the sine wave cycle need be considered. The linear PWM value is converted to a value in which each increment in value is proportional to equal power levels. The power level increments correspond directly to equal areas under a sine² curve. This is illustrated in FIG. 13 in which area 120 is the same as 122.

Selection of the AC or DC modes is done by a zero crossing detection system that senses when AC is applied. Transistor Q2 is connected to the rectified and unfiltered power source. When the voltage approaches a zero crossing it will drop below the threshold of Q2 and the transistor will turn off. This produces a pulse on the AC detect input to the microcontroller which is then used to synchronize the PWM. When operated on DC, Q2 will not change state which indicates to the microcontroller the presence of a DC power source.

Although examples of a flameless candle and its use have been described and illustrated in detail, it is to be understood that the same is intended by way of illustration and example only and is not to be taken by way of limitation. The invention has been illustrated configured with particular optional elements and circuit components. However, the flameless candle may be configured in a variety of ways and with varying circuit elements. For example, the flame simulation, trim ring, scent pack, globe, and globe insert, may be configured in any combination with one or more of the elements omitted. Likewise, analog or digital flame simulation circuits may be used. Also, the number of bulbs may be varied for different effects or cost targets. For example, a single bulb may be used in one embodiment to minimize cost. Two or more bulbs may be used in other instances to increase realism. Other kinds of light sources may be used in place of the illustrative incandescent bulbs. For example, the use of an LED light source may be advantageous in applications requiring batteries due to the lower power consumption of LED's versus incandescent bulbs.

The illustrative digital simulation circuit makes use of a small logic device and minimal external circuitry. All of the timing and lamp control is incorporated within the logic device. In the illustrative example, a microcontroller is used to generate and process the signals. Those skilled in the art will recognize that the same processes implemented by the microcontroller could also be implemented within a programmable logic device or in an application-specific integrated logic device. Such devices my also include the external components, such as transistors, without departing from the spirit of this invention.

Accordingly, variations in and modifications to the flameless candle and its use will be apparent to those of ordinary skill in the art, and such modifications and equivalents are encompassed in the invention.

What is claimed is:

1. A simulated open flame illumination device comprising:
a first light producing element;
a light driver operable to vary the light output intensity of the first light producing element over time, the light driver comprising:
a random number generator; and
a first controller operably connected to the first light producing element, the first controller being responsive to a random number generated by the random number generator to drive the light output intensity of the first light producing element to a random value, the duration that the first light producing element is driven at the random intensity also being random such that the light driver drives the first light producing element to produce random output intensities for random durations to mimic the dynamic characteristics of an open flame.

2. The simulated open flame illumination device of claim 1 wherein the light driver further comprises a time contour generator, the time contour generator being operable to contour the random duration to produce a relatively longer duration for intensity values nearer the center of the random number range and produce relatively shorter duration for intensity values nearer the extremes of the random number range to mimic the natural response of a flame to a disturbance.

3. The simulated open flame illumination device of claim 1 wherein the light driver further comprises an adaptive filter, the adaptive filter being operable to contour the transition from one intensity to the next to mimic the smooth transition between disturbances of a natural flame, the filter being responsive to higher numeric intensity values to respond more rapidly.

4. The simulated open flame illumination device of claim 3 wherein the adaptive filter has a nominal filter cutoff frequency, the filter cutoff frequency being adjusted in response to higher numeric values from the random number generator to respond more rapidly.

5. The simulated open flame illumination device of claim 4 wherein the nominal filter cutoff frequency is approximately 0.8 Hz.

6. The simulated open flame illumination device of claim 1 further comprising a second light producing element and wherein the light driver further comprises an adaptive filter, a first output value computation, a second output value computation, and a second controller operably connected to the second light producing element, the adaptive filter being operable to contour the transition from one intensity to the next to mimic the smooth transition between disturbances of a natural flame, the filter being responsive to higher numeric values from the random number generator to respond more rapidly, the first output value computation utilizing the output from the adaptive filter to produce a value for the first controller, the second output value computation utilizing the output from the adaptive filter to produce a value for the second controller, the second output value computation producing a more widely variable brightness range than the first output value computation, the light driver being responsive to the output value of the secondary output value computation to illuminate the second light producing element only when the output value exceeds a threshold value.

7. The simulated open flame illumination device of claim 6 wherein the threshold value is approximately 33% of the full-scale intensity value.

8. The simulated open flame illumination device of claim 1 wherein the light producing element comprises an incandescent bulb and further wherein the controller outputs a low value which keeps a filament in the light producing element at a temperature less than but near the incandescent temperature of the element to limit the inrush current when the bulb is illuminated.

9. The simulated open flame illumination device of claim 6 further comprising a third light producing element, the second and third light producing elements being horizontally offset from one another and vertically offset above the first light producing element, the light driver being operable to selectively illuminate one of the second and third light producing elements while the other of the second and third light producing elements remains unilluminated such that the second and third light producing elements alternate in a random pattern to mimic the lateral and vertical movement of a natural flame.

10. The simulated open flame illumination device of claim 1 wherein the first controller comprises a PWM controller operable to produce a PWM signal derived from the random number generator to randomly vary the output intensity of the first light producing element, the output intensity of the first light producing element being approximately proportional to the duty cycle of the PWM signal.

11. The simulated open flame illumination device of claim 10 wherein the first light producing element has a range of brightness variation from at least 60% to about 100% of full power output.

12. The simulated open flame illumination device of claim 1 further comprising an alternating current power input, the light driver being operable to synchronize the PWM output to the alternating current input with a period equal to half that of the alternating current input, the light driver being further operable to adjust the PWM period to produce equal steps of power delivered to the light producing element.

13. A method of simulating open flame illumination, comprising:
illuminating a first light producing element for a first random duration at a first random intensity level; and
illuminating the first light producing element for a second random duration at a second random intensity level to mimic the dynamic characteristics of an open flame.

14. The method of claim 13 further comprising:
contouring the duration of each intensity level to produce a relatively longer duration for intensity values nearer the center of the random intensity range and produce a relatively shorter duration for intensity values nearer the extremes of the random intensity range to mimic the natural response of a flame to a disturbance.

15. The method of claim 13 further comprising:
using an adaptive filter to contour the transition from one intensity level to the next to mimic the smooth transition between disturbances of a natural flame, the filter being responsive to higher numeric intensity values to respond more rapidly.

16. The method of claim 13 further comprising:
illuminating a second light producing element with a more widely variable random brightness range than the first light producing element and illuminating the second light producing element only when a computed output value exceeds a threshold value.

17. The method of claim 16 wherein the threshold value is approximately 33% of the full-scale intensity value.

18. The method of claim 13 further, comprising:
providing second and third light producing elements offset horizontally from one another and vertically above the first light producing element; and
selectively illuminating one of the second and third light producing elements while the other of the second and third light producing elements remains unilluminated such that the second and third light producing elements alternate in a random pattern to mimic both the lateral and vertical movement of a natural flame.

19. The method of claim 13 further, comprising:
driving the first light producing element with a PWM signal such that the output intensity of the first light producing element is proportional to the duty cycle of the PWM signal.
